(19) United States
(12) Patent Application Publication
(10) Pub. No.: US 2014/0318289 A1
(43) Pub. Date: Oct. 30, 2014

(54) WORM GEAR MECHANISM

(71) Applicant: HONDA MOTOR CO., LTD., MINATO-KU, TOKYO (JP)

(72) Inventors: Yosuke Tanaka, Wako-shi (JP); Yasuo Shimizu, Wako-shi (JP)

(21) Appl. No.: 14/358,094

(22) PCT Filed: Oct. 5, 2012
(86) PCT No.: PCT/JP2012/075949

§ 371 Date: May 14, 2014

(30) Foreign Application Priority Data
Nov. 16, 2011 (JP) 2011-250764

(51) Int. Cl. F16H 1/20; F16H 55/06

(52) U.S. Cl. CPC F16H 1/203; F16H 55/06
USPC 74/89.14

(57) ABSTRACT

A worm gear mechanism includes a worm connected to an electric motor, and a worm wheel engaged with the worm. In the worm wheel, a tooth flank is formed of a resin material. In the tooth flank, an engagement recess, which is based on a trajectory of a contact point being in contact with a tooth of the worm according to a rotation of the worm, is formed by injection molding, together with the tooth flank, using a mold. The engagement recess includes a plurality of points which are recessed in the direction of a tooth of the tooth flank correspondingly to the trajectory of the contact point with which the most convex portion of the tooth of the worm is in contact. A line connecting the plurality of points interconnects with respect to a tooth width center line of the tooth flank of the worm wheel.

### TECHNICAL FIELD

The present invention relates to an improved worm gear mechanism.

### BACKGROUND ART

A worm gear mechanism is used in an electric power steering apparatus. The worm gear mechanism includes a worm connected to an electric motor, and a worm wheel connected to a load. A torque produced by the electric motor is transmitted from the worm through the worm wheel to the load.

Recently, there is an increased demand for reduction in size and weight of the electric power steering apparatus, as well as for a high output of the electric motor. The electric power steering apparatus cannot be downsized without reducing the size of the worm gear mechanism. However, merely reducing the size of the worm gear mechanism without lowering a torque of the electric motor increases contact pressures exerted by a tooth of the worm and teeth of the worm wheel on each other.

Contact pressures exerted by tooth surfaces of the worm and the worm wheel on each other can be inhibited by forming the worm wheel teeth from an easily deformable resin material, for example, a resin material containing a small amount of glass fiber. However, this approach would advance a creep occurring on the tooth surfaces of the teeth of the worm wheel, causing an increase in backlash between the teeth. The increase in backlash causes the teeth to tend to produce a noise by hitting each other. Further, a steering feeling can also be worsened. Although, to address these problems, there is a need for an adjustment mechanism for adjusting the backlash, such an adjustment mechanism makes a structure of the worm gear mechanism complicated.

It is well-known in the art to form meshing grooves on tooth surfaces of teeth of a worm wheel, as disclosed in patent literature 1 below. A worm wheel of a worm gear mechanism of an electric power steering apparatus disclosed in patent literature 1 is a resin-made product. As for this worm wheel, after molding a worm wheel, a tool having super hard abrasive grains adhering thereto is used to form the meshing grooves on the tooth surfaces of the teeth of the molded worm wheel. The meshing grooves are located centrally in a “tooth trace” direction of the tooth surfaces, extend from a tooth root to a tooth tip, and are depressed in a tooth thickness direction.

However, such a technique as disclosed in patent literature 1 leaves a room for improvement to inhibit an abrasion occurring on the tooth surfaces of the resin-made worm wheel. A further development of a technique for enhancing a durability of the worm wheel is required.

### PRIOR ART LITERATURE

### Patent Literature

Patent Literature 1: JP-A-2009-192057

### SUMMARY OF INVENTION

### Technical Problem

An object of the present invention is to provide a technique for enhancing a durability of a worm wheel.

### Solution to Problem

According to one aspect of the present invention, as defined in claim 1, there is provided a worm gear mechanism for transmitting to steerable wheels a torque produced by an electric motor based on a steering input to a steering wheel, the mechanism comprising: a worm connected to the electric motor; and a worm wheel meshing with the worm, wherein the worm wheel has a tooth surface at least made from a resin material, and the tooth surface has a meshing recessed portion formed thereon, the meshing recessed portion being based on a locus of contact points contacting a tooth of the worm as the worm rotates, the meshing recessed portion being formed together with the tooth surface, only by injection molding using a mold, wherein the meshing recessed portion has a plurality of most depressed points in a tooth trace direction of the tooth surface of the worm wheel, in correspondence to a locus of contact points contacted by most convex portions of the tooth of the worm, and wherein a line interconnecting the plurality of the points intersects a face width centerline of the tooth surface of the worm wheel.

Preferably, as defined in claim 2, the meshing recessed portion defines a groove having a depth set to be larger in a region of a tip of a tooth of the worm wheel and a region of a root of the tooth of the worm wheel than in a region located therebetween.

### Advantageous Effects of Invention

As defined in claim 1, the worm wheel has the tooth surface at least made from the resin material. On the tooth surface, the meshing recessed portion is formed based on the locus of contact points contacting the tooth of the worm as the worm rotates. The meshing recessed portion has the plurality of most depressed points in the tooth trace direction of the tooth surface of the worm wheel, in correspondence to the locus of contact points contacted by the most convex portions of the tooth of the worm. The line interconnecting the plurality of the points intersects the face width centerline of the tooth surface of the worm wheel. Such a meshing recessed portion is depressed to conform to the locus of contact of the tooth surface of the tooth of the worm. This results in a significantly efficient increase in an area of contact between the tooth surface of the worm and the tooth surface of the worm wheel. The increase in the contact area between the tooth surfaces reduces contact pressures applied to the tooth surfaces. Thus, an abrasion occurring on the respective tooth surfaces can be inhibited to thereby enhance a durability of the worm and the worm wheel.

The meshing recessed portion is formed together with the tooth surface of the worm wheel, only by injection molding using the mold. The meshing recessed portion formed only by the injection molding using the mold has a smooth surface. Thus, the teeth can smoothly mesh with each other. Since the worm gear mechanism achieves a better meshing engagement between the worm and the worm wheel, a steering feeling in the electric power steering apparatus can be enhanced. Forming the meshing recessed portion on the tooth surface of the worm wheel does not require any process subsequent to the injection molding. It is not likely that the surface of the meshing recessed portion is roughened by the subsequent process. It is possible to easily ensure hardness of the surface of the meshing recessed portion, as well as to reduce a friction resistance occurring when this surface contacts the tooth of the worm and thus lessen a heat generation resulting from the friction resistance. It is possible to enhance a torque transmission efficiency of the worm gear mechanism.

Regarding claim 2, the meshing recessed portion does not have a uniform groove depth. That is, the meshing recessed portion defines a groove having a depth set to be larger in the region of the tip of the tooth of the worm wheel and the region of the root of the tooth of the worm wheel than in the region located therebetween. Typically, when the tooth surfaces of the worm gear mechanism contact each other, the regions of the tip and root of the tooth of the worm wheel are subjected to large contact pressures. Taking this into consideration, the depth of the meshing recessed portion is reasonably set to increase the area of the contact between the tooth surfaces. This results in reduction in the contact pressures exerted on the tooth surfaces. It is thus possible to inhibit an abrasion and heat generation occurring on the respective tooth surfaces to thereby enhance a durability of the worm and the worm wheel.

### BRIEF DESCRIPTION OF DRAWINGS

FIG. 1 is a diagrammatical view of an electric power steering apparatus including a worm gear mechanism in an embodiment 1 of the present invention;

FIG. 2 is a view showing an entire structure of the electric power steering apparatus shown in FIG. 1;

FIG. 3 is a cross-sectional view taken along line 3-3 of FIG. 2;

FIG. 4 is a cross-sectional view taken along line 4-4 of FIG. 2;

FIG. 5 is an enlarged cross-sectional view of a worm gear mechanism shown in FIG. 4;

FIG. 6 is a view showing that a tooth of a worm shown in FIG. 5 is sectioned at plural portions thereof in a whole depth direction of the tooth;

FIG. 7 is a view showing that a tooth surface of the tooth of the worm shown in FIG. 6 is pressed by a tooth surface of a tooth of a worm wheel;

FIG. 8 is a view showing one tooth of the worm wheel shown in FIG. 7 as the tooth is viewed from a side of a tooth surface of the tooth;

FIG. 9 is a view showing that the tooth of the worm wheel shown in FIG. 8 has actual meshing recessed portions formed on opposite tooth surfaces thereof;

FIG. 10 is a view showing a method for manufacturing a worm wheel shown in FIG. 3; and

FIG. 11 is a view showing that a tooth of a worm wheel in an embodiment 2 of the present invention has actual meshing recessed portions formed on opposite tooth surfaces thereof.

### DESCRIPTION OF EMBODIMENT

Certain preferred embodiments of the present invention are described below with reference to the accompanying drawings.

### Embodiment 1

A method for manufacturing a worm gear mechanism according to an embodiment 1 and an electric power steering apparatus including the worm gear mechanism is discussed below.

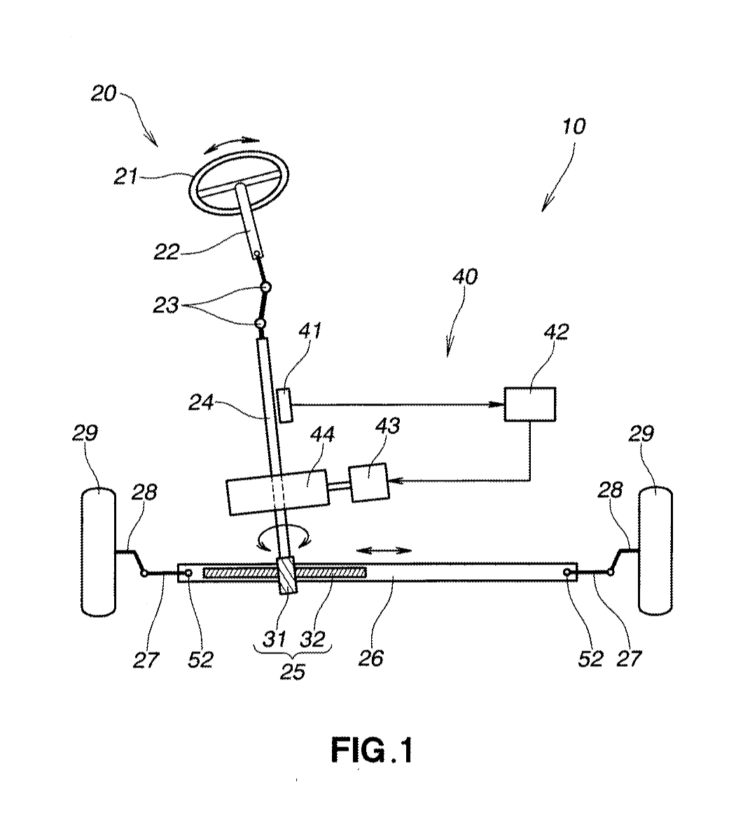

As shown in FIG. 1, an electric power steering apparatus 10 in the embodiment 1 includes a steering system 20 from a vehicular steering wheel 21 to vehicular steerable wheels 29, 29 (e.g., steerable front wheels), and an auxiliary torque mechanism 40 for providing an auxiliary torque to the steering system 20.

In the steering system 20, the steering wheel 21 is connected through a steering shaft 22 and universal joints 23, 23 to a pinion shaft (rotational shaft) 24. The pinion shaft 24 is connected through a rack-and-pinion mechanism 25 to a rack shaft 26. The rack shaft 26 has opposite ends connected through left and right tie rods 27, 27 and knuckles 28, 28 to the left and right steerable wheels 29, 29.

The rack-and-pinion mechanism 25 includes a pinion 24 formed on the pinion shaft 24 and a rack 32 formed on the rack shaft 26.

As for the steering system 20, a driver steers the steering wheel 21 to produce a steering torque in steering the left and right steerable wheels 29, 29 via the rack-and-pinion mechanism 25 and the left and right tie rods 27, 27.

In the auxiliary torque mechanism 40, a steering torque sensor 41 detects a steering torque applied by the driver to the steering wheel 21. A control unit 42 generates a control signal based on a torque detection signal from the steering torque sensor 41. Based on the control signal, an electric motor 43 produces an auxiliary torque corresponding to the steering torque. The auxiliary torque is transmitted through a worm gear mechanism 44 to the pinion shaft 24 and then to the rack-and-pinion mechanism 25.

The steering torque sensor 41 detects a torque applied to the pinion shaft 24 and outputs a torque detection signal. The steering torque sensor 41 is, for example, a magnetostriction torque sensor.

In the electric power steering apparatus 10, the auxiliary torque produced by the electric motor 43 is added to the steering torque produced by the driver to provide a composite torque to be transmitted to the rack shaft 26 for steering the steerable wheels 29, 29. That is, the electric power steering apparatus 10 steers the vehicle by transmitting the torque, produced by the electric motor 43 based on a steering input to the steering wheel 21, to the left and right steerable wheels 29, 29 via the worm gear mechanism 44.

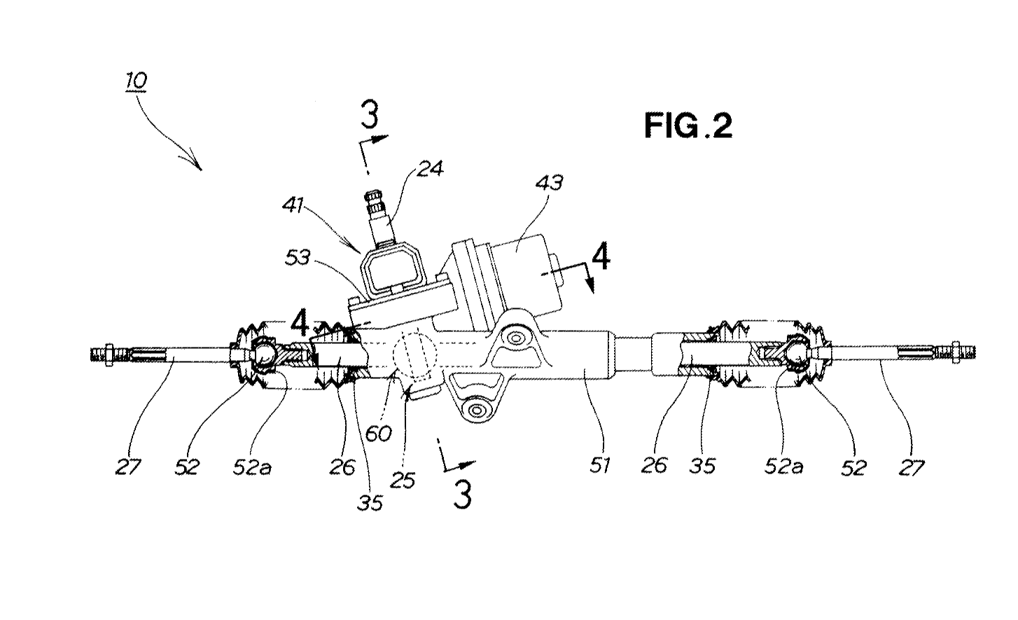

As shown in FIG. 2, a housing 51 extends laterally of the vehicle, and the rack shaft 26 is axially slidably accommodated in the housing 51. The rack shaft 26 has longitudinal opposite ends projecting out of the housing 51 and connected through ball joints 52, 52 to the tie rods 27, 27.

The housing 51 has opposite ends located laterally of the vehicle and the opposite ends of the housing 51 are equipped with stoppers 35, 35. The ball joints 52, 52 have rack ends 52a, 52a (abutment end surfaces) opposed to the stoppers 35, 35. The rack shaft 26 is axially slidable until the rack ends 52a, 52a abut on the stoppers 35, 35.

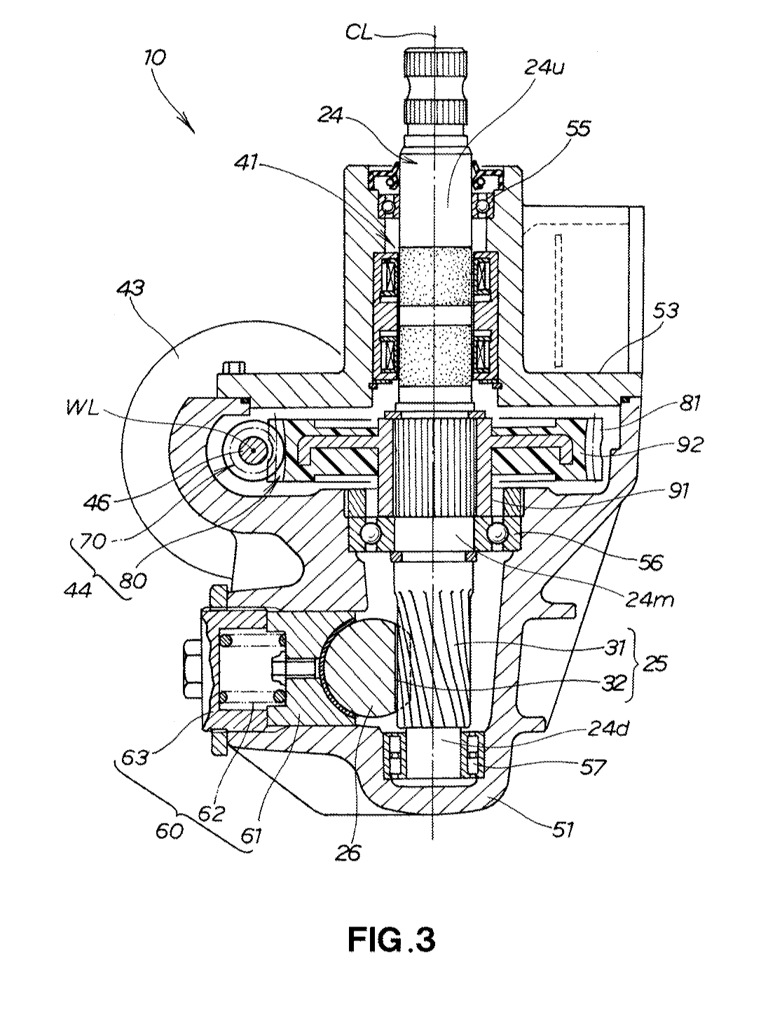

As shown in FIG. 3, in the electric power steering apparatus 10, the pinion shaft 24, the rack-and-pinion mechanism 25, the steering torque sensor 41 and the worm gear mechanism 44 are received in the housing 51, and the housing 51 has an upper opening closed by an upper cover member 53. The steering torque sensor 41 is mounted to the upper cover member 53.

The housing 51 rotatably supports upper, longitudinal central, lower end portions 24u, 24m, 24d of the vertically extending pinion shaft 24 through three bearings (first, second and third bearings 55, 56, 57 arranged in order in a downward direction). The electric motor 43 is mounted to the housing 51, and the housing 51 includes a rack guide 60.

The rack guide 60 is pressing means including a guide portion 61 located opposite the rack 32 and abutting on the rack shaft 26, and an adjustment bolt 63 pushing the guide portion 61 by means of a compression spring 62.

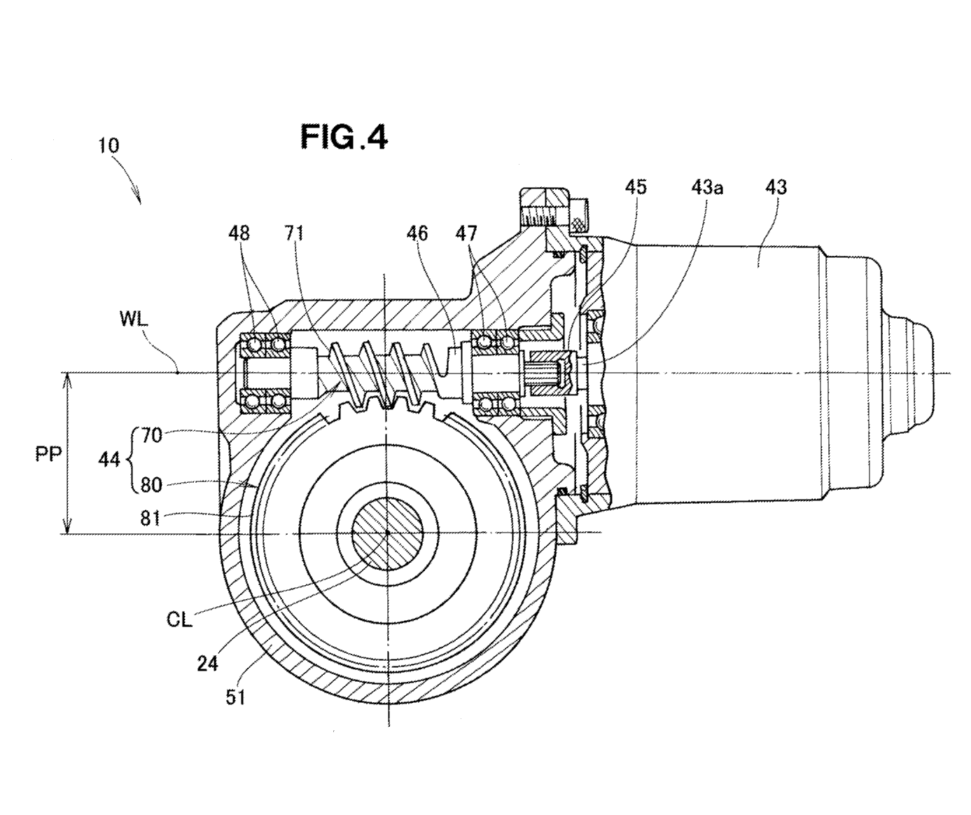

As shown in FIG. 4, the electric motor 43 includes a horizontally oriented motor shaft 43a and is mounted to the housing 51. The motor shaft 43a extends within the housing 51 and is connected to a worm shaft 46 by a coupling 45. The housing 51 rotatably supports opposite ends of the horizontally extending worm shaft 46 through bearings 47, 48.

As shown in FIG. 3 and FIG. 4, the worm gear mechanism 44 is an auxiliary torque transmitting mechanism, i.e., a servo mechanism for transmitting an auxiliary torque, produced by the electric motor 43, to the pinion shaft 24. More specifically, the worm gear mechanism 44 includes a worm 70 connected to the electric motor 43, and a worm wheel 80 meshing with the worm 70. The worm wheel 80 is hereinafter simply referred to as “wheel 80”.

The worm 70 is formed integrally with the worm shaft 46. The wheel 80 is mounted to the pinion shaft (rotational shaft) 24 such that the wheel 80 undergoes very limited axial and rotational movement relative to the pinion shaft 24. The drive-side worm 70 meshes with the load-side wheel 80 to transmit a torque from the worm 70 through the wheel 80 to a load. The pinion shaft 24 has a center CL offset a distance PP from a centerline WL of the worm shaft 46.

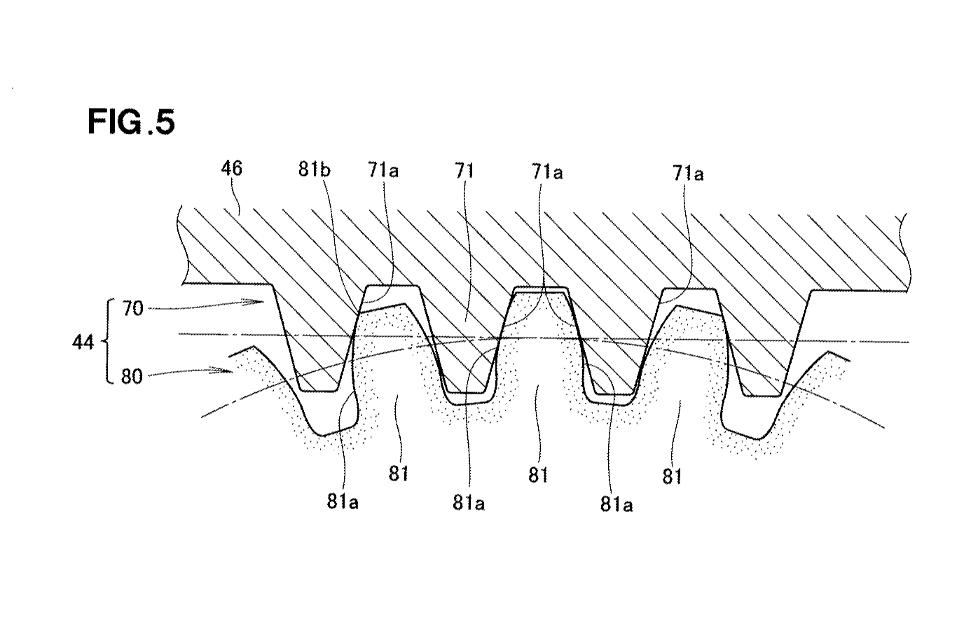

The worm 70 is a metal product, e.g., a steel material product formed of carbon steel material for machine structural use (JIS-G-4051) etc. The wheel 80 has teeth 81 having tooth surfaces 81a (FIG. 5) which is at least formed of resin material such as nylon resin. As shown in FIG. 3, for example, the wheel 80 includes a metal boss portion 91 fittingly mounted on the pinion shaft 24, and a resinous wheel body 92 integrally molded with the boss portion 91. The plurality of the teeth 81 are formed on the entire outer circumference of the wheel body 92. The wheel 80 is an entirely resin-molded product.

As shown in FIG. 5, the tooth surfaces 81a of the metal teeth 81 of the resinous wheel 80 engage tooth surfaces 71a of a metal tooth 71 of the worm 70 to allow for smooth meshing engagement between the teeth 81 and the tooth 71 as well as to reduce a noise.

Since the tooth 71 of the worm 70 is made from metal, the tooth 71 has a high rigidity and is difficult to elastically deform. In contrast, the teeth 81 of the wheel 80 are made from resin and, thus have a relatively low rigidity and are easier to elastically deform than the worm 70. The teeth 81 of the wheel 80 can elastically deform in accordance with a magnitude of an auxiliary torque as the wheel 80 is rotated by the worm 70. As a result, the plurality of the teeth 81 of the wheel 80 simultaneously meshes with the tooth 71 of the worm 70.

The worm 70 has a single thread (i.e., the tooth 71) set thereon, and the thread 71 has a constant pitch. The tooth 71 of the worm 70 has a tooth profile taking, e.g., an “involute” or “roughly trapezoidal” shape. The teeth 81 of the wheel 80 are teeth for a “helical” gear or a “spur” gear. Each of the teeth 81 has a tooth profile taking the shape of an “involute”. The tooth 71 of the worm 70 has the same pressure angle as those of the teeth 81 of the wheel 80.

As the wheel 80 is rotated by the worm 70, a meshing engagement between the tooth 71 of the worm 70 and any one of the teeth 81 of the wheel 80 is made through the following series of changes:

(1) First, a dedendum portion or flank of the tooth surface 71a of the tooth 71 pushes a tip 81b of a tooth 81 of the wheel 80 (a first contact step).

(2) Subsequently, the flank of the tooth surface 71a of the tooth 71 of the worm 70 contacts and then pushes an addendum portion or face of a tooth surface 81a of the tooth 81 of the wheel 80 (a second contact step).

(3) Further, a portion of the tooth surface 70a on a pitch circle of the worm 70 contacts and then pushes a portion of the tooth surface 81a on a pitch circle of the wheel 80 (a third contact step).

(4) Furthermore, an addendum portion or face of the tooth surface 71a of the worm 70 contacts and then pushes a dedendum portion or flank of the tooth surface 81a of the wheel 80 (a fourth step).

As is discussed above, as the plurality of the teeth 81 of the wheel 80 simultaneously mesh with the tooth 71 of the worm 70, the teeth 81 elastically deform (flex) by substantially the same amounts. However, the tooth surfaces 81a of these teeth 81 contact the tooth 71 of the worm 70 at different points. That is, at these different contact points, the tooth surfaces 81a bear different loads from the tooth 71 of the worm 70, such that the plurality of the teeth 81 flex by the same amounts. This means that contact pressures exerted on the respective contact points are different from one another. Particularly, in the first contact step and the fourth contact step, the contact point is subjected to a greater contact pressure than in the other contact steps.

The tooth surface 81a contacts the tooth 71 of the worm 70 at a contact point which varies or shifts in a “tooth trace” direction (a face width direction) of the tooth surface 81a as the worm 70 rotates. A reason why the contact point shifts is discussed below.

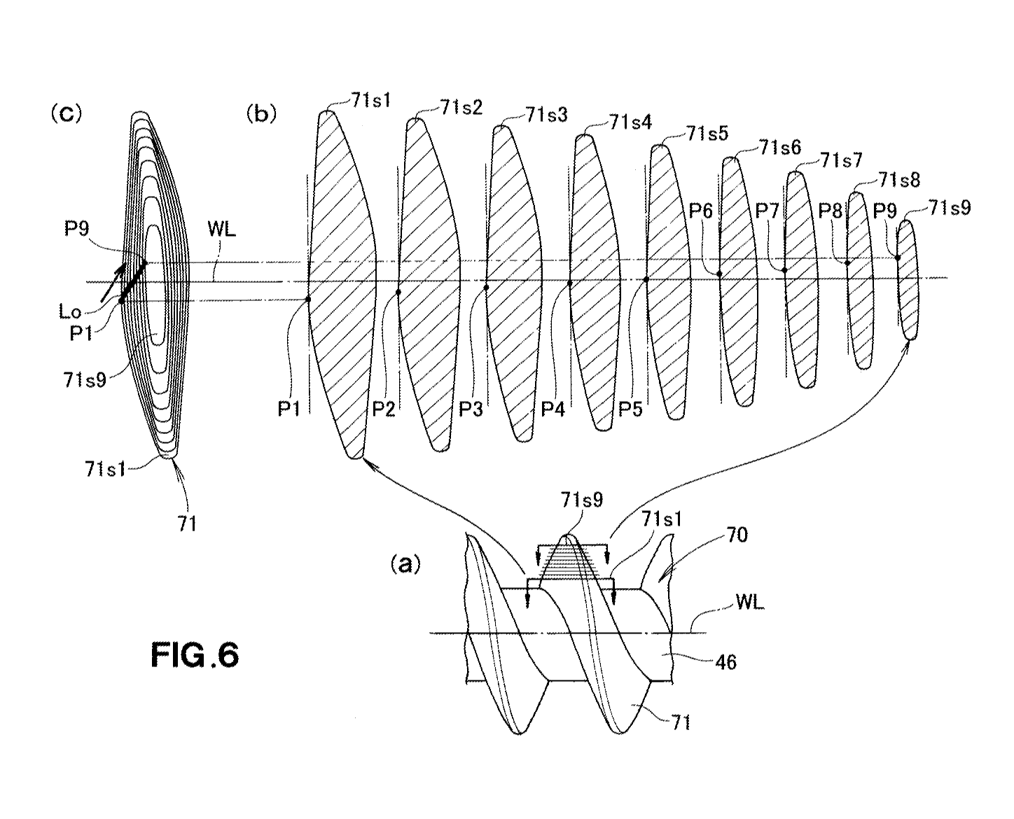

FIG. 6(a) is a perspective view of the worm 70 having the tooth 70 of the “involute” tooth profile. FIG. 6(b) shows cross-sections of a plurality of portions of the tooth 71 shown in FIG. 6(a) in a whole depth direction, which portions are, e.g., nine portions equally spaced from one another. The whole depth is a radial distance between a tip or addendum circle and a root circle. FIG. 6(c) shows the tooth 71, shown in FIG. 6(a), in the form of contour lines as the tooth 71 is viewed in a direction from a top land of the tooth 71. A plurality of cross-sections 71s1 to 71s9 shown in FIG. 6(b) are arranged in an overlapping relationship to show the tooth 71 in the form of the contour lines of FIG. 6(c) as the tooth 71 is viewed in the direction from the top land of the tooth 71.

FIG. 6(a) to FIG. 6(c) show that the “tooth trace” of the tooth 71 has a convex shape in a direction along the centerline WL of the worm shaft 46. A lead angle increases from a root of the tooth 71 to the tip of the tooth 71, thereby increasing a slope of the tooth 71. As a result, it turns out that meshing points P1, P9 are offset from the centerline WL of the worm shaft 46.

That is, through the plurality of the cross-sections 71s1 to 71s9, a most projecting point (a most convex portion) varies from a point P1 to a point P9 in a direction from the root of the tooth 71 to the tip of the tooth 71. The cross-section 71s1 of the portion of the tooth 71 in a vicinity of a bottom land of the worm 70 has the projecting point P1 projecting most in the direction along the centerline WL of the worm shaft 46, and the point P1 is greatly offset radially from the centerline WL. The cross-sections 71s4 to 71s6 of the portions of the tooth 71 in a vicinity of a pitch circle of the tooth 71 have the projecting points P4 to P6 projecting most in the direction along the centerline WL of the worm shaft 46, and the points P4 to P6 are disposed roughly on the centerline WL. The cross-section 71s9 of the portion of the tooth 71 in a vicinity of the tip of the tooth 71 has the projecting point P9 projecting most in the direction along the centerline WL of the worm shaft 46, and the point P9 is greatly offset radially from the centerline WL.

The projecting points P1, P9 are offset from the centerline WL in the opposite directions. Thus, as shown in FIG. 6(c), the projecting point varies from the point P1 to the point P9 in a direction intersecting the centerline WL of the worm shaft 46. The projecting points P1 to P9 of the plurality of the cross-sections 71s1 to 71s9 are arranged to provide a locus Lo extending from the root of the tooth 71 to the tip of the tooth 71.

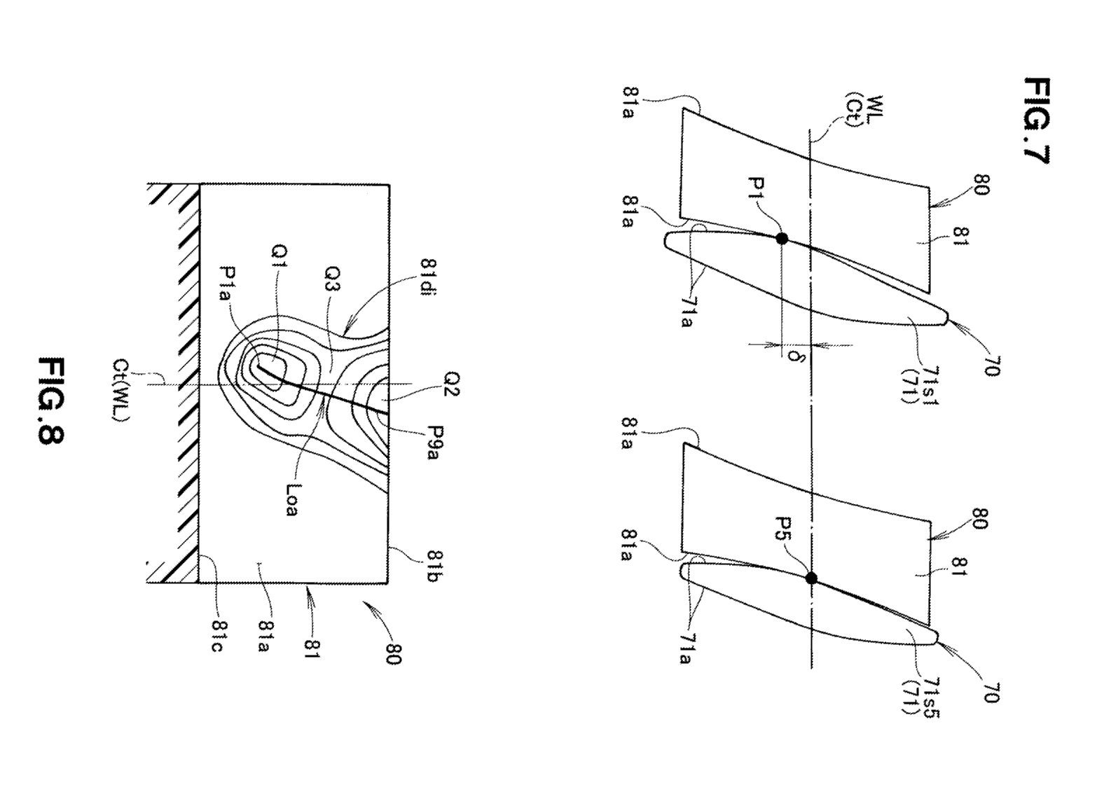

FIG. 7 shows that the tooth surface 71a of the tooth 71 of the worm 70 is pressed against the tooth surface 81a of the tooth 81 of the wheel 80.

FIG. 7(a) shows that, at the cross-section 71s1 of the portion of the tooth 71 in the vicinity of the bottom land of the worm 70, the tooth surface 71a contacts the tooth surface 81a of the tooth 81 of the wheel 80. The projecting point P1 is offset an offset amount δ from a face width centerline Ct in a “tooth trace” direction (a face width direction), which centerline Ct is a centerline of the tooth surface 81a of the wheel 80 in the face width direction. The face width centerline Ct coincides with the centerline WL of the worm shaft 46.

FIG. 7(b) shows that, at the cross-section 71s5 of the portion of the tooth 71 in the vicinity of the pitch circle of the tooth 71 shown in FIG. 6(b), the tooth surface 71a contacts the tooth surface 81a of the tooth 81 of the wheel 80. The projecting point P5 is located roughly on the face width centerline Ct.

FIG. 8 shows one tooth 81 of the wheel 80 as the one tooth 81 is viewed from a side of the tooth surface 81a. On the tooth surface 81a of the tooth 81 of the wheel 80, an ideal meshing recessed portion 81di is formed. This meshing recessed portion 81di is formed on the basis of a curve Loa interconnecting contact points Pla to P9a of the tooth 81 of the wheel 80 contacting the tooth 71 of the worm 70 as the worm 70 rotates. The meshing recessed portion 81di has a region which is deepest depressed in the tooth surface 81a, and the curve Loa passes on the deepest depressed region of the meshing recessed portion 81di.

The meshing recessed portion 81di has a depth distribution shown by contour lines of FIG. 8. The depth distribution of the meshing recessed portion 81di is as follows. The point Pla located in a vicinity of a bottom land 81c and a region Q1 (a lower recessed part Q1) surrounding the point Pla have a large depth. The point P9a located in a vicinity of the tip 81b and a region Q2 (an upper recessed part Q2) surrounding the point P9a have a large depth. A region Q3 (an intermediate recessed part Q3) between the lower recessed part Q1 and the upper recessed part Q2 has a depth smaller than the depths of the lower recessed part Q1 and the upper recessed part Q2. Thus, the meshing recessed portion 81di defines a groove having a depth set to be larger in a region of the tip 81b and a region of a root of the tooth 81 of the wheel 80 than in a region located therebetween.

The meshing recessed portion 81di has the plurality of the most depressed points Pla to P9a in the tooth trace direction of the tooth surface 81a of the wheel 80, in correspondence to the locus Lo of the contact points P1 to P9 contacted by the most projecting points (the most convex portions) of the tooth 71 of the worm 70 shown in FIG. 6. The curve Loa interconnecting the plurality of the points Pla to P9a intersects the face width centerline Ct of the tooth surface 81a of the wheel 80.

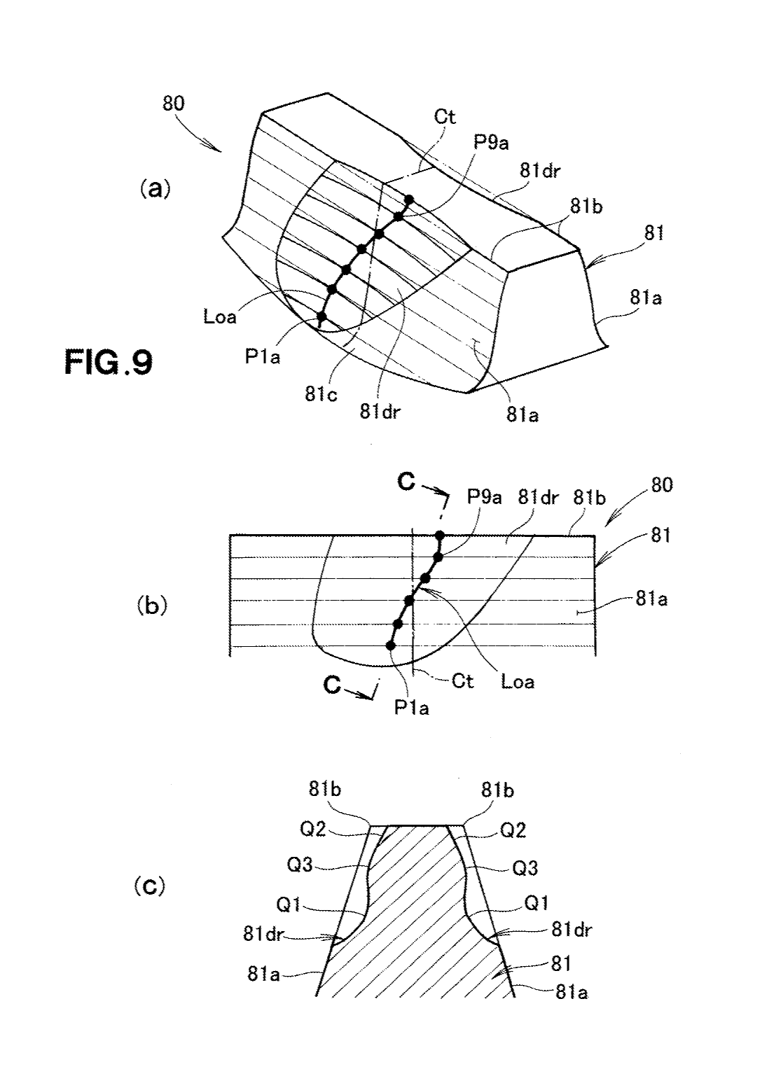

FIG. 9(a) shows that actual meshing recessed portions 81dr, 81dr are formed on opposite tooth surfaces 81a, 81a of the tooth 81 of the wheel 80. FIG. 9(b) is a view of the actual meshing recessed portion 81dr shown in FIG. 9(a) as the actual meshing recessed portion 81dr is viewed from a side of the tooth surface 81a. FIG. 9(c) is a cross-sectional view taken along line c-c of FIG. 9(b).

Referring to FIG. 9(a) to FIG. 9(c), in the embodiment 1, the actual meshing recessed portion 81dr corresponds to the ideal meshing recessed portion 81di. Further, the actual meshing recessed portion 81dr has an outline as viewed from the side of the tooth surface 81a, which outline is simpler than that of the ideal meshing recessed portion 81di shown in FIG. 8. This means that a mold for forming the meshing recessed portion 81di can be simplified.

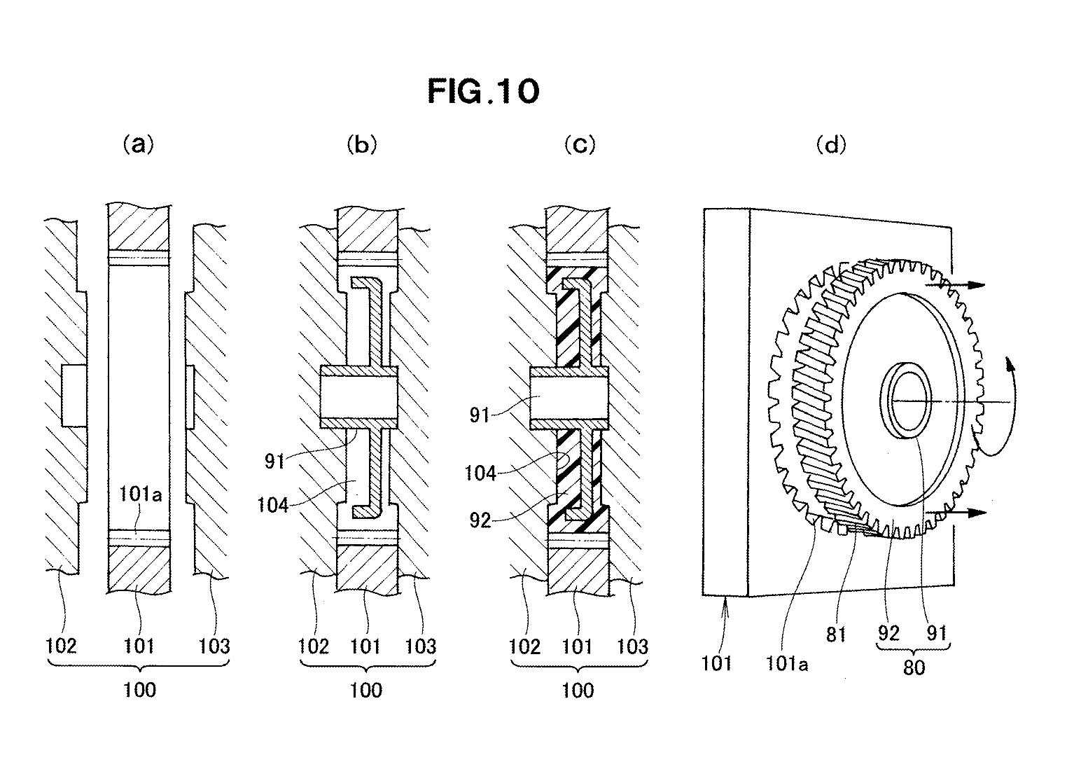

Next, a method for manufacturing the wheel 80 is discussed with reference to FIG. 10.

As shown in FIG. 10(a), initially, a mold 100 for injection-molding the wheel 80 is provided (a provision step). The mold 100 includes, for example, a stationary hollow mold member 101 (an intermediate mold 101), and a pair of movable mold members 102, 103 to be assembled to opposite surfaces of the stationary mold member 101 in an overlapping relationship. The stationary mold member 101 is a member for forming an outer circumferential portion of the resinous wheel body 92 and the teeth 81. The stationary mold 101 has a plurality of tooth-shaped portions 101a formed on an inner circumferential surface thereof for forming the teeth 81 and the actual meshing recessed portions 81dr simultaneously (FIG. 9).

As shown in FIG. 10(b), next, the metal boss portion 91 is set between the pair of movable mold members 102, 103, and then mold 100 is brought to a closed position to form a cavity 104 (a cavity forming step).

As shown in FIG. 10(c), subsequently, a molten resin is injected into the cavity 104 to injection-mold the wheel 80 (a wheel molding step). As a result, the wheel 80 is formed together with the actual meshing recessed portions 81dr.

Finally, after the resin within the cavity 104 is hardened, the mold 100 is brought to an open position to allow removal of the wheel 80, thereby completing the manufacturing process (a wheel removal step). A resin shrinks by being cooled. A small gap is formed between the shrunken resin and the mold 100. Using this gap, the wheel 80 can be removed from the mold 100. For example, gaps sized to allow for the removal of the wheel 80 are set between the teeth 81 of the wheel 80 and the tooth-shaped portions 101a of the stationary mold member 101 after the wheel 80 is cooled. Where the teeth 81 of the wheel 80 are teeth for a “helical” gear, the wheel 80 can be removed from the stationary mold member 101 as the wheel 80 is rotated in a direction of slope of the tooth 81, as shown in FIG. 10(d). As is clear from the foregoing description, the actual meshing recessed portion 81dr (FIG. 9) is formed together with the tooth surface 81a of the tooth 81, only by injection molding using the mold 100.

### Embodiment 2

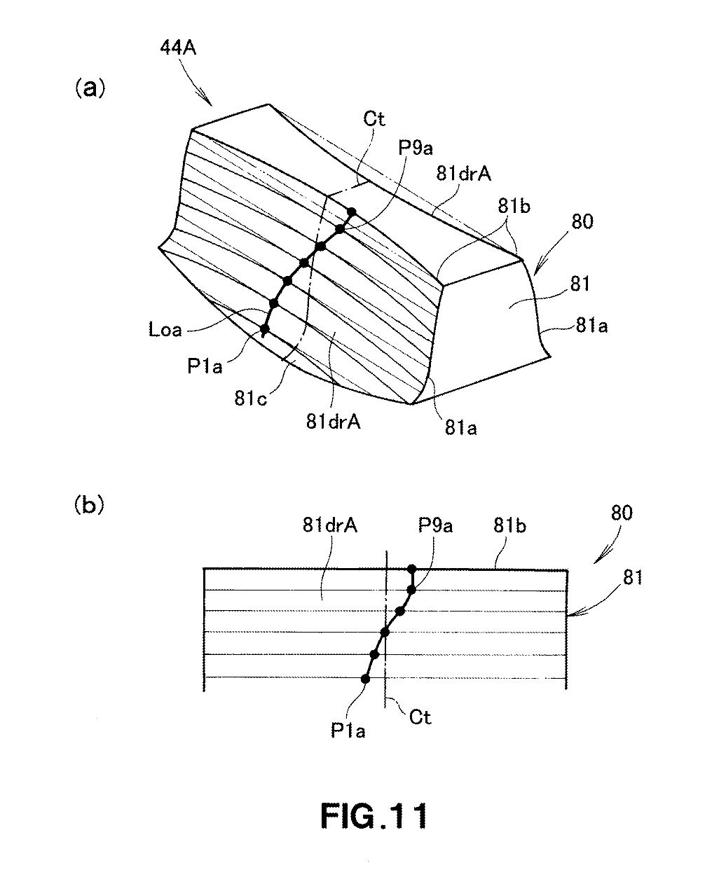

Next, a method for manufacturing a worm gear mechanism 44A in an embodiment 2 is discussed with reference to FIG. 11. FIG. 11(a) corresponds to FIG. 9(a). FIG. 11(b) corresponds to FIG. 9(b).

The worm gear mechanism 44A in the embodiment 2 has actual meshing recessed portions 81drA formed on tooth surfaces 81a, 81a of a tooth 81 of a worm wheel 80. The other elements shown in the embodiment 2 are substantially the same as those in the embodiment 1, and these other elements are denoted by the same reference numerals as those in the embodiment and descriptions of the other elements are omitted.

That is, the actual meshing recessed portion 81dr in the embodiment 1 shown in FIG. 9 is formed on one part of the tooth surface 81a. In contrast, the actual meshing recessed portions 81drA in the embodiment 2 shown in FIGS. 11(a) and (b) are each formed all over the tooth surface 81a.

The discussions of the embodiments 1 and 2 are summarized as follows.

The tooth surface 81a of the wheel 80 is made from a resin material. Formed on the tooth surface 81a is the meshing recessed portion 81dr or 81drA based on the locus Lo of the contact points P1 to P9 contacting the tooth 71 of the worm 70 as the worm 70 rotates. The meshing recessed portion 81dr or 81drA has the plurality of the most depressed points Pla to P9a in the tooth trace direction of the tooth surface 81a of the wheel 80, in correspondence to the locus Lo of the contact points P1 to P9 contacted by the most convex portions of the tooth 71 of the worm 70. The line Loa interconnecting the plurality of the points Pal to P9a intersects the face width centerline Ct of the tooth surface 81a of the wheel 80. Such a meshing recessed portion 81dr or 81drA is depressed to conform to the locus Lo of contact of the tooth surface 71a of the tooth 71 of the worm 70.

This results in a significantly efficient increase in an area of contact between the tooth surface 71a of the worm 70 and the tooth surface 81a of the wheel 80. The increase in the contact area between the tooth surfaces 71a, 81a reduces contact pressures applied to the tooth surfaces 71a, 81a. Thus, an abrasion occurring on the respective tooth surfaces 71a, 81a can be inhibited to thereby enhance a durability of the worm 70 and the wheel 80.

The meshing recessed portions 81dr, 81drA are formed together with the tooth surface 81a of the wheel 80, only by injection molding using the mold 100. The meshing recessed portions 81dr, 81drA formed only by the injection molding using the mold 100 have smooth surfaces. Thus, the teeth 71, 81 can smoothly mesh with each other. Since the worm gear mechanisms 44, 44A achieve a better meshing engagement between the worm 70 and the wheel 80, a steering feeling in the electric power steering apparatus 10 can be enhanced.

Forming the meshing recessed portion 81dr or 81drA on the tooth surface 81a of the wheel 80 does not require any process subsequent to the injection molding. It is not likely that the surface of the meshing recessed portion 81dr or 81drA is roughened by the subsequent process. It is possible to easily ensure hardness of the surface of the meshing recessed portion, as well as to reduce a friction resistance occurring when this surface contacts the tooth 71 of the worm 70 and thus lessen a heat generation resulting from the friction resistance. It is possible to enhance torque transmission efficiencies of the worm gear mechanisms 44, 44A.

The meshing recessed portion 81dr or 81drA does not have a uniform groove depth. That is, the meshing recessed portion defines a groove having a depth set to be larger in the region of the tip 81b of the tooth 81 of the wheel 80 and the region of the root of the tooth 81 of the wheel 80 than in the region located therebetween. Typically, when the tooth surfaces 71a, 81a of the worm gear mechanisms 44, 44A contact each other, the regions of the tip 81b and root of the tooth 81 of the wheel 80 are subjected to large contact pressures. Taking this into consideration, the depths of the meshing recessed portions 81dr, 81drA are reasonably set to increase the area of the contact between the tooth surfaces 71a, 81a. This results in reduction in the contact pressures exerted on the tooth surfaces 71a, 81a. It is thus possible to inhibit an abrasion and heat generation occurring on the respective tooth surfaces 71a, 81a to thereby enhance a durability of the worm 70 and the wheel 80.

In the present invention, the electric power steering apparatus 10 is required only to turn the vehicle by transmitting through the worm gear mechanism 44 to the steerable wheels 29, 29 a torque produced by the electric motor 43 based on a steering input force applied to the steering wheel 21. For example, the worm gear mechanism 44 and the method for manufacturing the same is applicable to an electric power steering apparatus of steer-by-wire (SBW) type. This SBW type of the electric power steering apparatus is configured to include a steering wheel 21 and a pinion shaft 24 mechanically separate from the steering wheel and turn steerable wheels 29, 29 by transmitting through a worm gear mechanism 44 to the pinion shaft a steering torque produced by an electric motor 43 based on a steering input force.

### INDUSTRIAL APPLICABILITY

The worm gear mechanism 44 is suitable for a vehicular electric power steering apparatus 10 including a steering torque sensor 41 for detecting a steering torque produced by the steering wheel 21, and an electric motor 43 for producing an auxiliary torque in response to a detection signal from the steering torque sensor 41, such that the auxiliary torque is transmitted through the worm gear mechanism 44 to a steering system 20.

### Reference Signs List:

10 . . .an electric power steering apparatus, 21 . . . a steering wheel, 29 . . . steerable wheels, 43 . . . an electric motor, 44, 44A . . . worm gear mechanisms, 70 . . . a worm, 71 . . . a tooth of the worm, 71a . . . a tooth surface of the tooth of the worm, 80 . . . a worm wheel, 81 . . . a tooth of the worm wheel, 81a . . . a tooth surface, 81dr, 81drA . . . meshing recessed portions, 81b . . . a tip, 100 . . . a mold, Ct . . . a tooth width centerline of the tooth surface of the worm wheel, Lo . . . a locus of contact points contacting most convex portions of the tooth of the worm, Loa . . . a line interconnecting a plurality of points

1. A worm gear mechanism for transmitting to steerable wheels a torque produced by an electric motor based on a steering input to a steering wheel, the mechanism comprising:
a worm connected to the electric motor; and
a worm wheel meshing with the worm,
wherein the worm wheel has a tooth surface at least made from a resin material, and the tooth surface has a meshing recessed portion formed thereon, the meshing recessed portion being based on a locus of contact points contacting a tooth of the worm as the worm rotates, the meshing recessed portion being formed together with the tooth surface, only by injection molding using a mold,
wherein the meshing recessed portion has a plurality of most depressed points in a tooth trace direction of the tooth surface of the worm wheel, in correspondence to a locus of contact points contacted by most convex portions of the tooth of the worm, and
wherein a line interconnecting the plurality of the points intersects a face width centerline of the tooth surface of the worm wheel.

2. The worm gear mechanism of claim 1, wherein the meshing recessed portion defines a groove having a depth set to be larger in a region of a tip of a tooth of the worm wheel and a region of a root of the tooth of the worm wheel than in a region located therebetween.
